(19) United States
(12) Patent Application Publication
(10) Pub. No.: US 2026/0296865 A1
(43) Pub. Date: Oct. 1, 2026

(54) Lifting Apparatus

(71) Applicant: EZ Industries, LLC, Provo, UT (US)

(72) Inventor: Jared Johnson, Riverton, UT (US)

(21) Appl. No.: 19/634,232

(22) Filed: Mar. 31, 2026

Related U.S. Application Data
(60) Provisional application No. 63/781,307, filed on Mar. 31, 2025.
(60) Provisional application No. 63/854,439, filed on Jul. 30, 2025.

(51) Int. Cl. B66F 19/00

(52) U.S. Cl. CPC B66F 19/005

(57) ABSTRACT

A lifting apparatus includes a vertical shaft, and a magnetic engagement mechanism coupled to a first end of the vertical shaft, the first end being a bottom of the vertical shaft, wherein the magnetic engagement mechanism comprises a magnet that is configured to engage a metal object, wherein the magnetic engagement mechanism is configured to rotate relative to the vertical shaft. The lifting apparatus further includes a handle coupled to a second end of the vertical shaft, the second end being located at an opposite end of the vertical shaft from the first end, the second end being a top of the vertical shaft.

### RELATED APPLICATIONS

This application claims the benefit of U.S. Provisional Patent Application No. 63/781,307, filed Mar. 31, 2024, which is incorporated herein by reference in its entirety. This application also claims the benefit of U.S. Provisional Patent Application No. 63/854,439, filed Jul. 30, 2024, which is incorporated herein by reference in its entirety

### FIELD

This disclosure relates to an apparatus for lifting manhole covers, pipe, drain and other metal and/or cast-iron covers and the like.

### BACKGROUND

This disclosure relates to improvements to an apparatus for manhole covers, pipe, drain and other metal and/or cast-iron covers and the like. Lifting a manhole cover (or the like) can be a challenging and physically demanding task due to its weight and design. Typically made of cast iron or other heavy-duty materials, manhole covers can weigh anywhere from 50 to over 300 pounds, making them difficult to lift without the proper tools and technique. The lack of grip, combined with rust, corrosion, or debris buildup, can make removal even harder. Additionally, poor ergonomics, such as bending over and lifting incorrectly, can lead to significant strain on the body.

Attempting to lift a manhole cover without proper precautions can result in various injuries. Back injuries are common, especially when lifting with improper posture or using the back instead of the legs. Fingers and hands are at risk of being pinched or crushed if they get caught under the cover, while dropping the cover can lead to broken toes or foot injuries. Muscle strains in the arms, shoulders, or legs can occur due to the heavy lifting, and wet or uneven surfaces around the manhole can increase the risk of slips and falls. If the cover shifts unexpectedly, limbs may be trapped, causing severe injuries.

To lift a manhole cover safely, it is crucial to use the right tools, such as manhole hooks, magnetic lifters, or mechanical lifting devices, which help reduce strain. Proper lifting techniques, such as squatting and using leg strength rather than bending at the waist, can prevent back injuries. Wearing protective gear, including steel-toed boots, gloves, and safety glasses, helps minimize the risk of hand and foot injuries. Working with a partner can make the process safer, and ensuring the surrounding area is free of obstructions or slip hazards before lifting is also essential. Without these precautions, lifting a manhole cover can be hazardous and lead to serious injuries.

Embodiments of a lifting apparatus is disclosed herein.

Other aspects and advantages of embodiments of the present invention will become apparent from the following detailed description, taken in conjunction with the accompanying drawings, illustrated by way of example of the principles of the invention.

### SUMMARY

The subject matter of the present application has been developed in response to the present state of the art, and in particular, in response to the problems and disadvantages associated with conventional systems that have not yet been fully solved by currently available techniques. Accordingly, the subject matter of the present application has been developed to provide embodiments of systems, apparatuses, and methods and to overcome at least some of the shortcomings of prior art techniques

Disclosed herein is a lifting apparatus. A lifting apparatus includes a vertical shaft, and a magnetic engagement mechanism coupled to a first end of the vertical shaft, the first end being a bottom of the vertical shaft, wherein the magnetic engagement mechanism comprises a magnet that is configured to engage a metal object. The lifting apparatus further includes a handle coupled to a second end of the vertical shaft, the second end being located at an opposite end of the vertical shaft from the first end, the second end being a top of the vertical shaft. The preceding subject matter of this paragraph characterizes example 1 of the present disclosure.

The lifting apparatus further comprises a pin that couples the magnetic engagement mechanism to the vertical shaft and is configured to allow the vertical shaft to rotate relative to the magnetic engagement mechanism about the pin. The preceding subject matter of this paragraph characterizes example 2 of the present disclosure, wherein example 2 also includes the subject matter according to example 1, above.

The magnetic engagement mechanism further comprises a magnetic mechanism cover that covers the magnet and exposes the magnet on a bottom of the lifting apparatus. The preceding subject matter of this paragraph characterizes example 3 of the present disclosure, wherein example 3 also includes the subject matter according to any one of examples 1-2, above.

The magnetic mechanism cover comprises a channel which restricts motion of the vertical shaft in all directions except for one direction where the channel is formed. The preceding subject matter of this paragraph characterizes example 4 of the present disclosure, wherein example 4 also includes the subject matter according to any one of examples 1-3, above.

The magnet is coupled to the magnetic mechanism cover and the magnet is configured to spin or rotate relative to the magnetic mechanism cover. The preceding subject matter of this paragraph characterizes example 5 of the present disclosure, wherein example 5 also includes the subject matter according to any one of examples 1-4, above.

The magnet is configured to spin or rotate relative to the vertical shaft. The preceding subject matter of this paragraph characterizes example 6 of the present disclosure, wherein example 6 also includes the subject matter according to any one of examples 1-5, above.

The magnet is configured to spin or rotate relative to the handle. The preceding subject matter of this paragraph characterizes example 7 of the present disclosure, wherein example 7 also includes the subject matter according to any one of examples 1-6, above.

The handle comprises handle grips and a clamp that couples the handle grips to the vertical shaft. The preceding subject matter of this paragraph characterizes example 8 of the present disclosure, wherein example 8 also includes the subject matter according to any one of examples 1-7, above.

The handle grips are configured to rotate relative to the clamp. The preceding subject matter of this paragraph characterizes example 9 of the present disclosure, wherein example 9 also includes the subject matter according to any one of examples 1-8, above. In another example, the communication hardware is configured to utilize low power, below 30milliwatts.

The clamp further comprises clamp channels, wherein the clamp channels direct the handle grips between an up position and a down position relative to the vertical shaft. The preceding subject matter of this paragraph characterizes example 10 of the present disclosure, wherein example 10 also includes the subject matter according to any one of examples 1-9, above.

In the up position, the handle grips are perpendicular to the vertical shaft. The preceding subject matter of this paragraph characterizes example 11 of the present disclosure, wherein example 11 also includes the subject matter according to any one of examples 1-10, above.

In the down position, the handle grips are parallel to the vertical shaft. The preceding subject matter of this paragraph characterizes example 12 of the present disclosure, wherein example 12 also includes the subject matter according to any one of examples 1-11, above.

The clamp channels further comprise an overhang which forces the handle grips into either the up position or the down position. The preceding subject matter of this paragraph characterizes example 13 of the present disclosure, wherein example 13 also includes the subject matter according to any one of examples 1-12, above.

The magnetic engagement mechanism is configured to rotate relative to the vertical shaft. The preceding subject matter of this paragraph characterizes example 14 of the present disclosure, wherein example 14 also includes the subject matter according to any one of examples 1-13, above.

Disclosed herein is a lifting apparatus. A lifting apparatus includes a vertical shaft, and a magnetic engagement mechanism coupled to a first end of the vertical shaft, the first end being a bottom of the vertical shaft, wherein the magnetic engagement mechanism comprises a magnet that is configured to engage a metal object, wherein the magnetic engagement mechanism is configured to rotate relative to the vertical shaft. The lifting apparatus further includes a handle coupled to a second end of the vertical shaft, the second end being located at an opposite end of the vertical shaft from the first end, the second end being a top of the vertical shaft. The preceding subject matter of this paragraph characterizes example 15 of the present disclosure.

The lifting apparatus further includes a pin that couples the magnetic engagement mechanism to the vertical shaft and is configured to allow the vertical shaft to rotate relative to the magnetic engagement mechanism about the pin. The preceding subject matter of this paragraph characterizes example 16 of the present disclosure, wherein example 16 also includes the subject matter according to example 15, above.

The magnetic engagement mechanism comprises a channel which restricts motion of the vertical shaft in all directions except for one direction where the channel is formed. The preceding subject matter of this paragraph characterizes example 17 of the present disclosure, wherein example 17 also includes the subject matter according to any one of examples 15-16, above.

The magnet is configured to spin or rotate relative to the vertical shaft and handle. The preceding subject matter of this paragraph characterizes example 18 of the present disclosure, wherein example 18 also includes the subject matter according to any one of examples 15-17, above.

The handle comprises handle grips and a clamp that couples the handle grips to the vertical shaft, and wherein the handle grips are configured to rotate relative to the clamp. The preceding subject matter of this paragraph characterizes example 19 of the present disclosure, wherein example 19 also includes the subject matter according to any one of examples 15-18, above.

The lifting apparatus further comprises a pin that couples the magnetic engagement mechanism to the vertical shaft and is configured to allow the vertical shaft to rotate relative to the magnetic engagement mechanism about the pin. The magnetic engagement mechanism comprises a channel which restricts motion of the vertical shaft in all directions except for one direction where the channel is formed. The magnet is configured to spin or rotate relative to the vertical shaft and handle The preceding subject matter of this paragraph characterizes example 20 of the present disclosure, wherein example 20 also includes the subject matter according to any one of examples 15-19, above.

Throughout this application, similar designations or vocabulary may be used to identify similar elements, although the breadth of this disclosure should be understood to incorporate any alternatives and variations referenced within the specification (including the claims) and the accompanying drawings.

### BRIEF DESCRIPTION

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered limiting of its scope, the subject matter will be described and explained with additional specificity and detail through the use of the drawings.

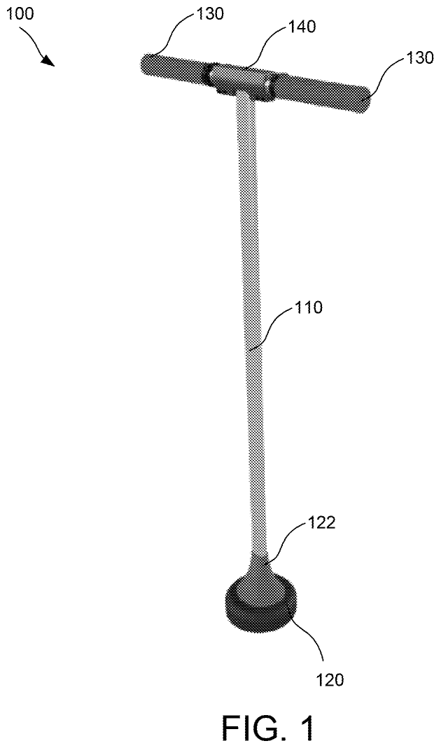

FIG. 1 depicts a perspective view of a lifting apparatus, according to one or more embodiments of this disclosure.

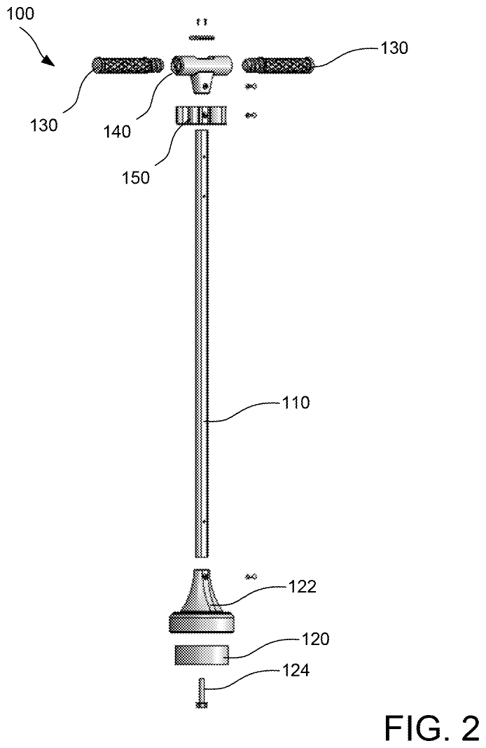

FIG. 2 depicts an exploded perspective view of a lifting apparatus, according to one or more embodiments of this disclosure.

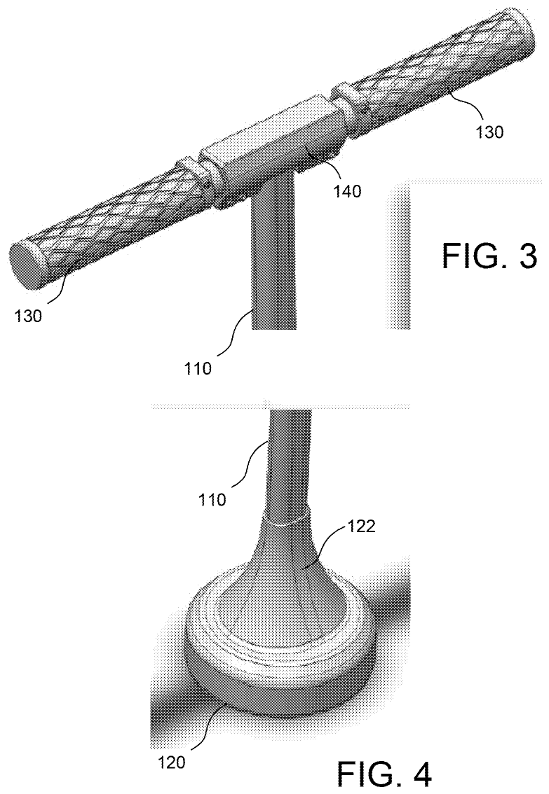

FIG. 3 depicts a detail perspective view of a handle of a lifting apparatus, according to one or more embodiments of this disclosure.

FIG. 4 depicts a detail perspective view of a magnetic engagement mechanism of a lifting apparatus, according to one or more embodiments of this disclosure.

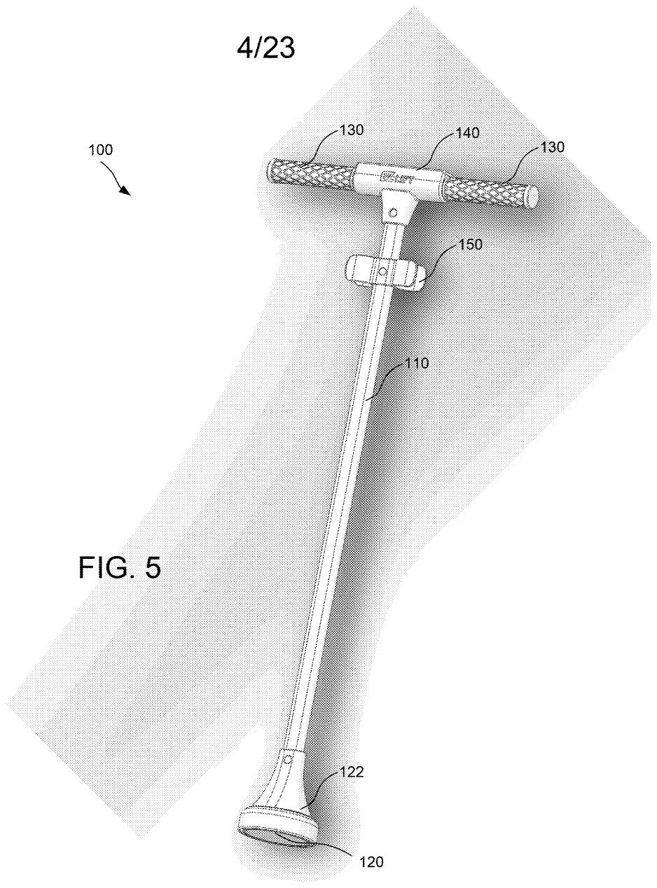

FIG. 5 depicts a perspective view of a lifting apparatus, according to one or more embodiments of this disclosure.

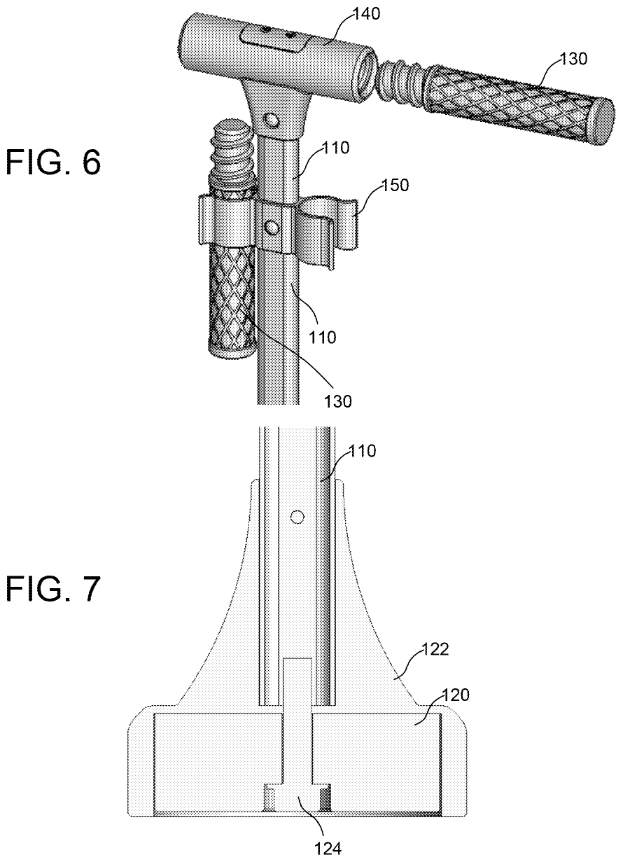

FIG. 6 depicts a perspective view of a handle of a lifting apparatus resting in a partially disassembled state, according to one or more embodiments of this disclosure.

FIG. 7 depicts a cross-sectional side view of a magnetic engagement mechanism of a lifting apparatus, according to one or more embodiments of this disclosure.

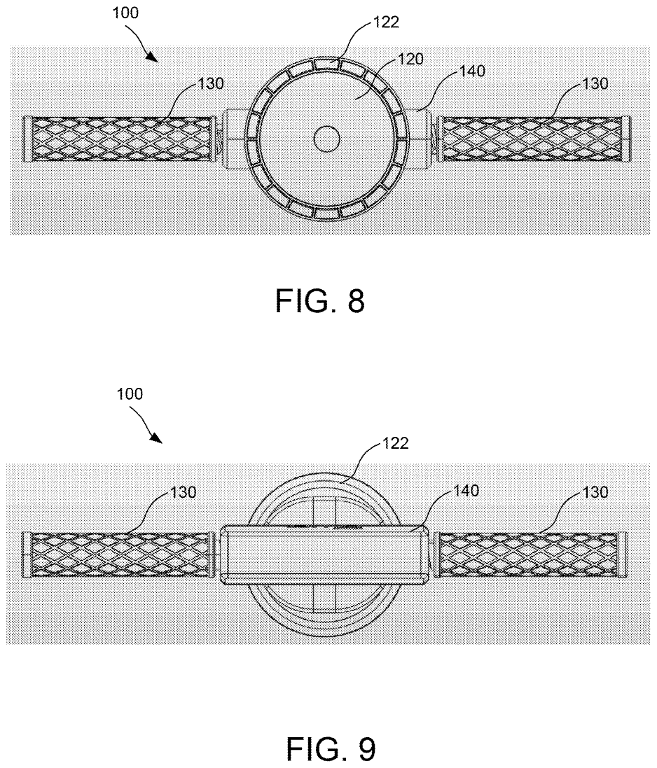

FIG. 8 depicts a bottom view of a lifting apparatus, according to one or more embodiments of this disclosure.

FIG. 9 depicts a top view of a lifting apparatus, according to one or more embodiments of this disclosure.

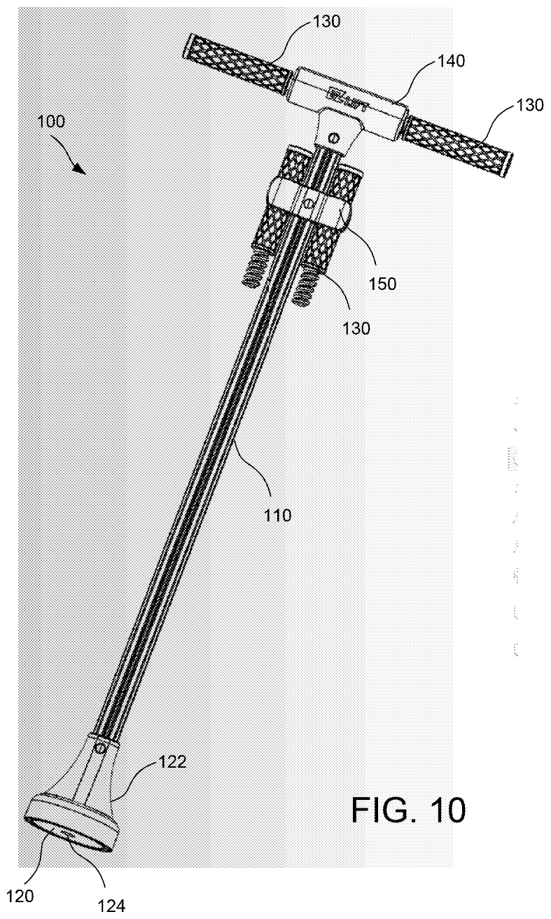

FIG. 10 depicts a front perspective view of a lifting apparatus, according to one or more embodiments of this disclosure.

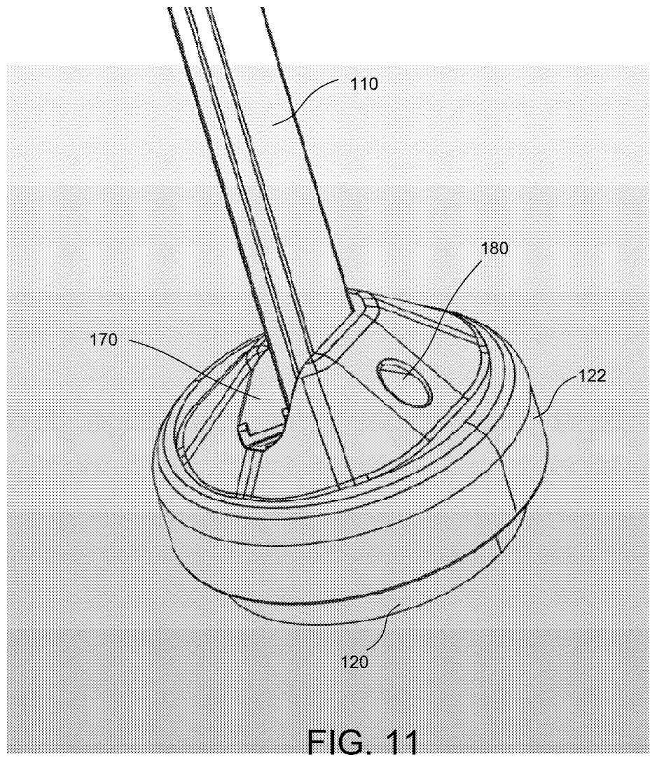

FIG. 11 depicts a perspective view of a magnetic engagement mechanism of a lifting apparatus, according to one or more embodiments of this disclosure.

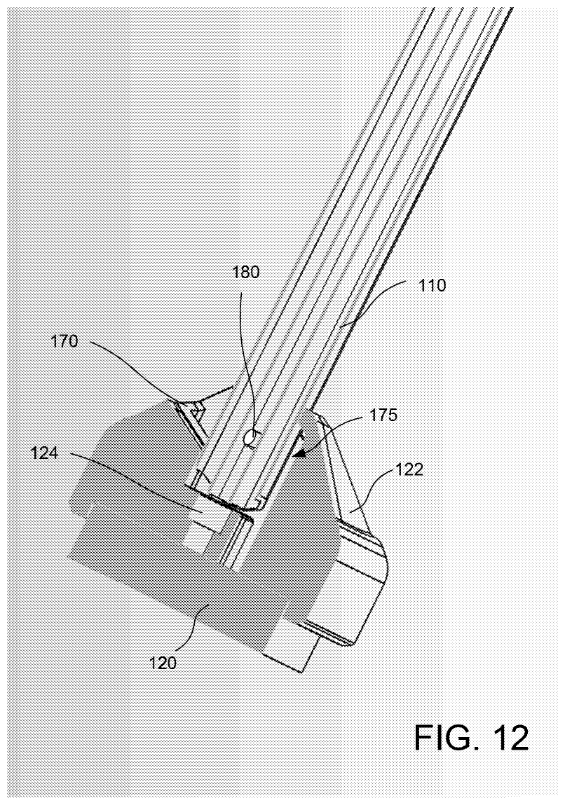

FIG. 12 depicts a perspective cut-away view of a magnetic engagement mechanism of a lifting apparatus, according to one or more embodiments of this disclosure.

FIG. 13 depicts a side cutaway view of a magnetic engagement mechanism of a lifting apparatus, according to one or more embodiments of this disclosure.

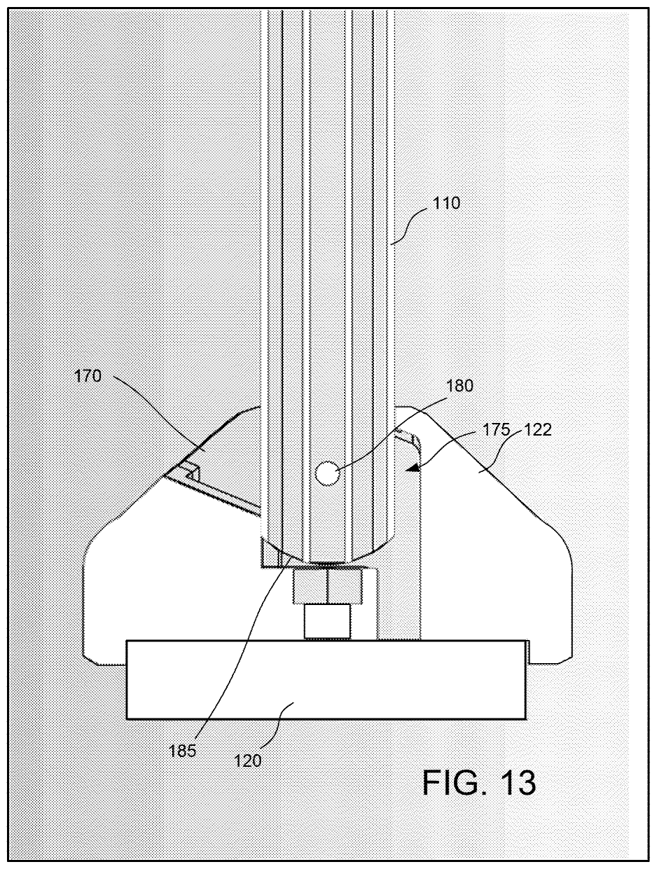

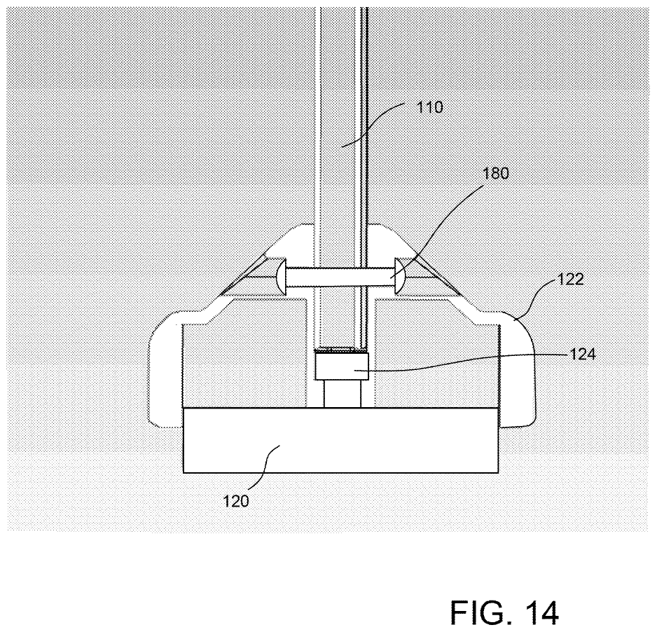

FIG. 14 depicts a front cutaway view of a magnetic engagement mechanism of a lifting apparatus, according to one or more embodiments of this disclosure.

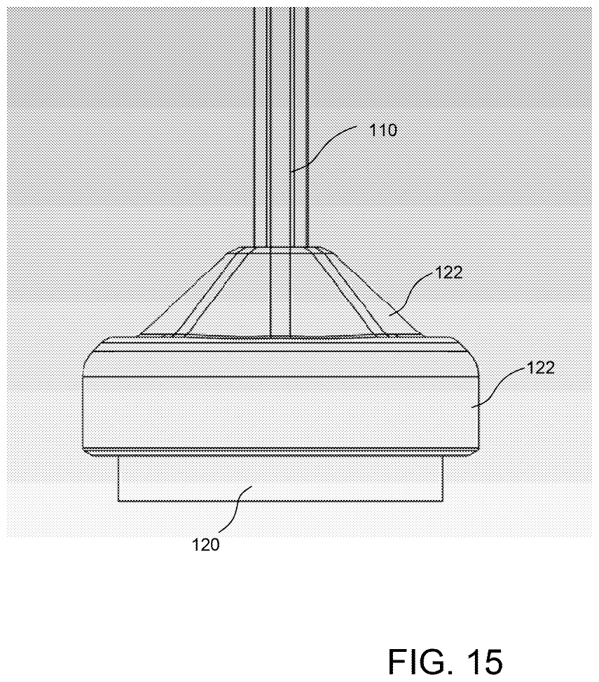

FIG. 15 depicts a rear view of a magnetic engagement mechanism of a lifting apparatus, according to one or more embodiments of this disclosure.

FIG. 16 depicts a bottom view of a lifting apparatus, according to one or more embodiments of this disclosure.

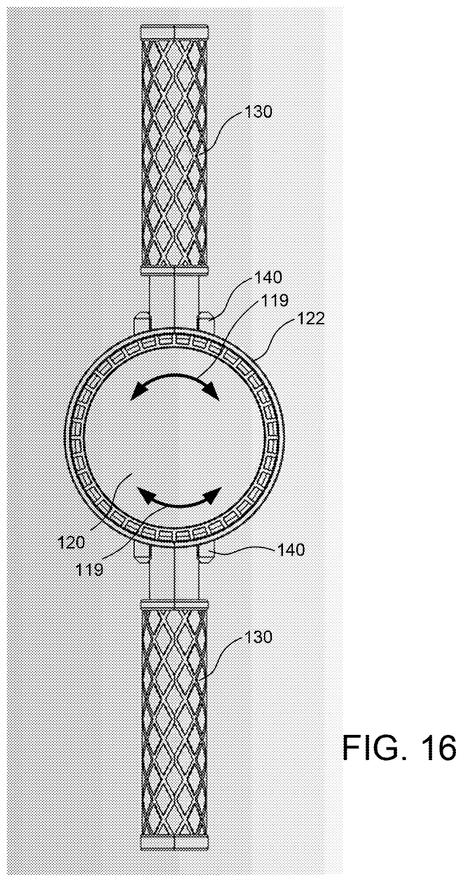

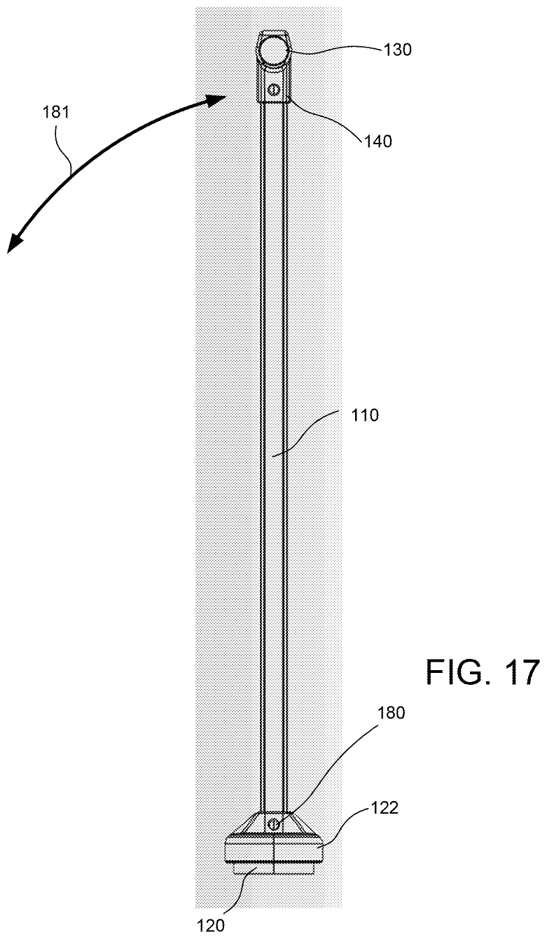

FIG. 17 depicts a side view of a lifting apparatus, according to one or more embodiments of this disclosure.

FIG. 18 depicts a front view of a lifting apparatus, according to one or more embodiments of this disclosure.

FIG. 19 depicts a front view of a handle of a lifting apparatus, according to one or more embodiments of this disclosure.

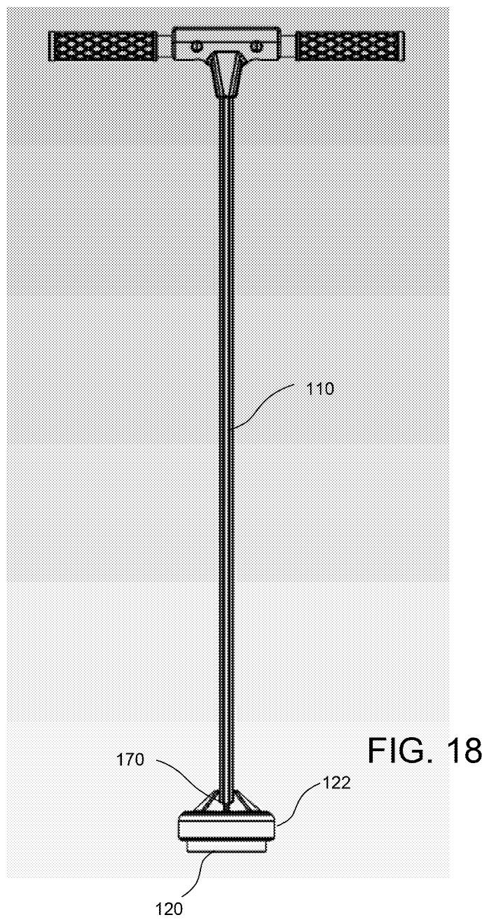

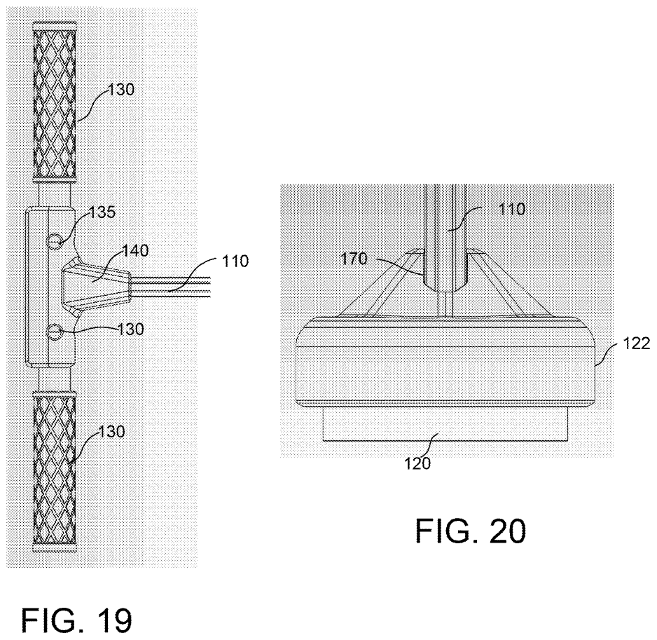

FIG. 20 depicts a front view of a magnetic engagement mechanism of a lifting apparatus, according to one or more embodiments of this disclosure.

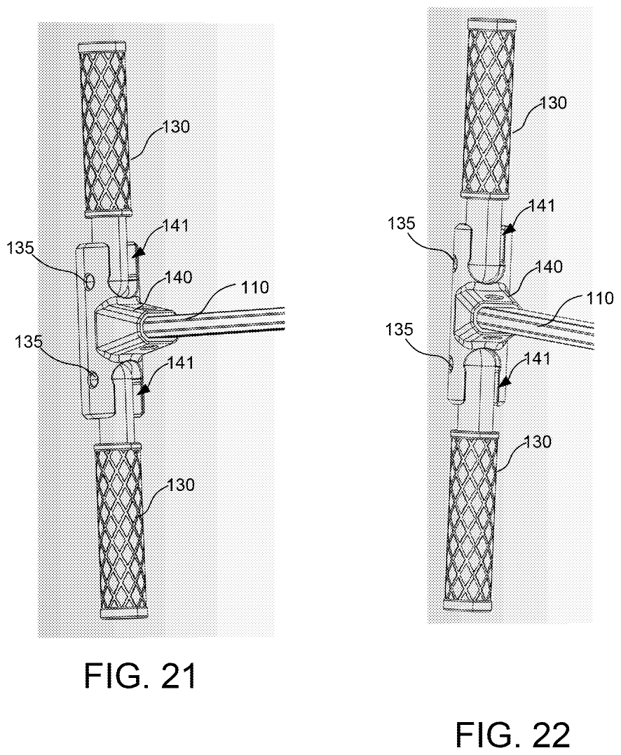

FIG. 21 depicts a bottom perspective view of a handle of a lifting apparatus, according to one or more embodiments of this disclosure.

FIG. 22 depicts a bottom perspective view of a handle of a lifting apparatus, according to one or more embodiments of this disclosure.

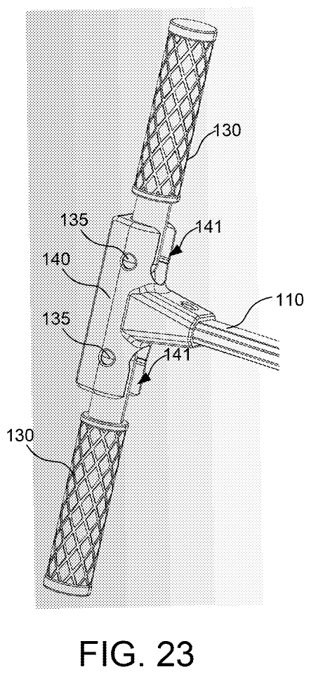

FIG. 23 depicts a perspective view of a handle of a lifting apparatus, according to one or more embodiments of this disclosure.

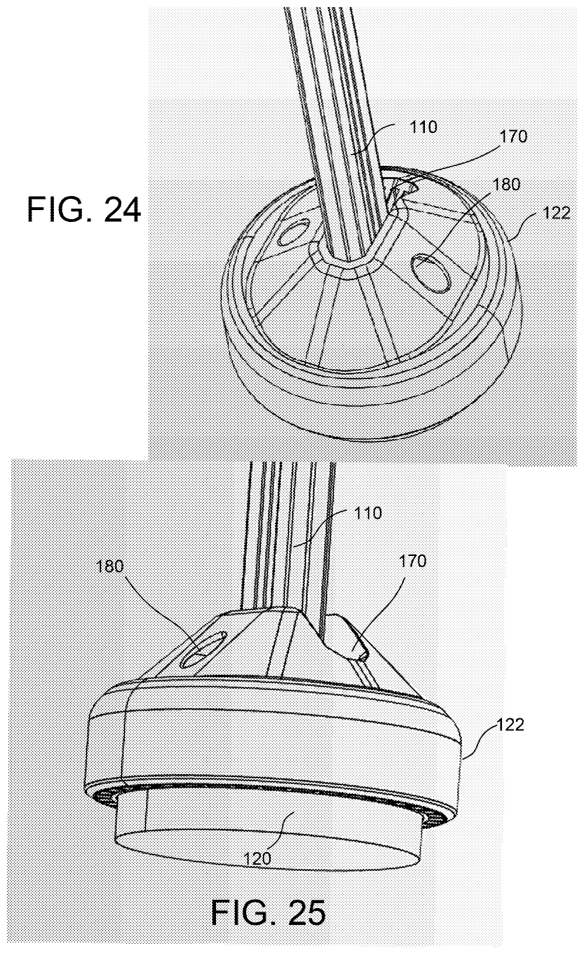

FIG. 24 depicts a rear perspective view of a magnetic engagement mechanism of a lifting apparatus, according to one or more embodiments of this disclosure.

FIG. 25 depicts a front perspective view of a magnetic engagement mechanism of a lifting apparatus, according to one or more embodiments of this disclosure.

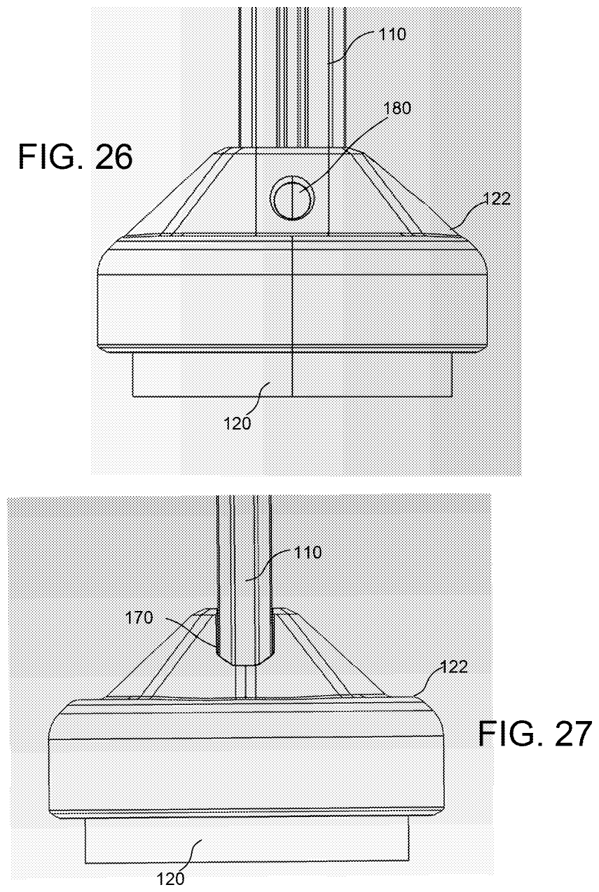

FIG. 26 depicts a side view of a magnetic engagement mechanism of a lifting apparatus, according to one or more embodiments of this disclosure.

FIG. 27 depicts a front view of a magnetic engagement mechanism of a lifting apparatus, according to one or more embodiments of this disclosure.

FIG. 28 depicts a lifting apparatus is shown in use, according to one or more embodiments of this disclosure.

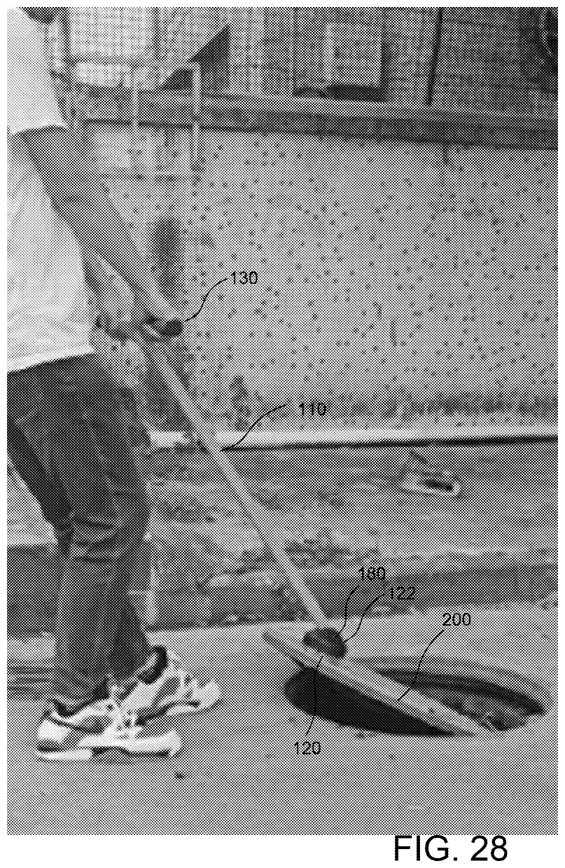

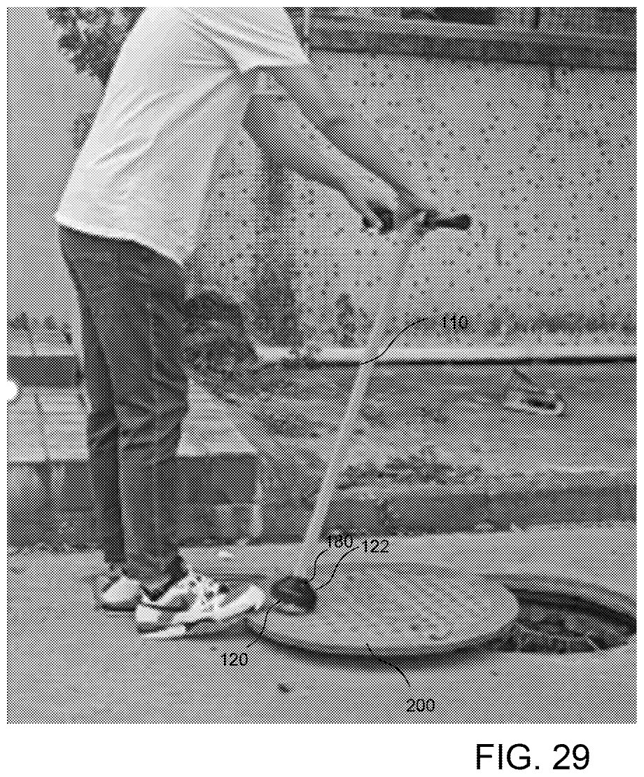

FIG. 29 depicts a lifting apparatus is shown in use, according to one or more embodiments of this disclosure.

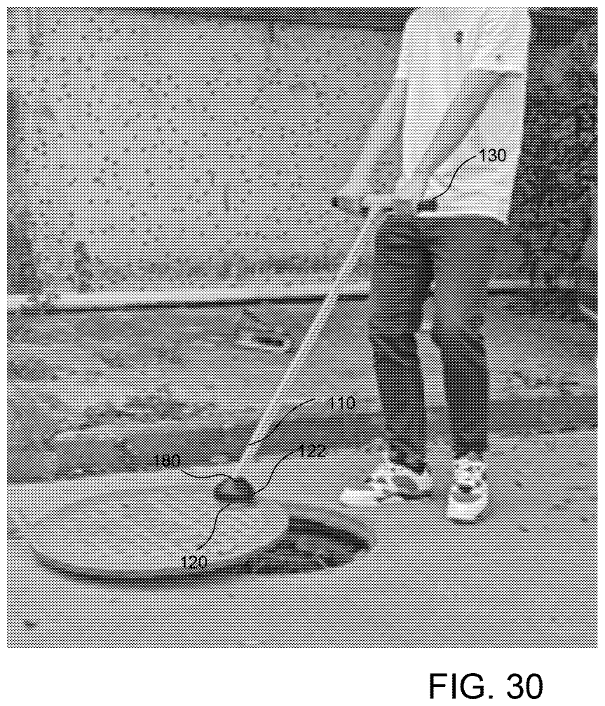

FIG. 30 depicts a lifting apparatus is shown in use, according to one or more embodiments of this disclosure.

Throughout the description, similar reference numbers may be used to identify similar elements. Throughout this application, similar designations or vocabulary may be used to identify similar elements, although the breadth of this disclosure should be understood to incorporate any alternatives and variations referenced within the specification (including the claims) and the accompanying drawings.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Various Figures and Drawings are shown to give an idea to the scope of the embodiments of the invention. These figures are not meant to be limiting but illustrative to one skilled in the art.

FIG. 1 depicts a perspective view of a lifting apparatus 100, according to one or more embodiments of this disclosure. Although the lifting apparatus 100 is shown and described with certain components and functionality, other embodiments of the lifting apparatus 100 may include fewer or more components to implement less or more functionality. This is applicable to each Figure below as well. Each individual component may include fewer or more subcomponents or features to implement less or more functionality. The descriptions are merely illustrative.

The lifting apparatus 100 includes a handle (see FIG. 3 for more detail), a shaft 110, and a magnetic engagement mechanism (see FIGS. 4 and 7 for more detail). The handle, shaft and magnetic engagement mechanism are coupled together to create the lifting apparatus 100 that is depicted in FIG. 1. Generally speaking the lifting apparatus includes a vertical shaft between a specialized handle at a top of the apparatus and the magnetic engagement mechanism at a bottom of the apparatus. As manhole covers are heavy, the apparatus may be constructed of sturdy and durable materials that can withstand large tensile forces.

The lifting apparatus 100 is used by engaging the magnetic engagement mechanism to the top of a manhole cover, pipe, drain and other metal and/or cast-iron cover and the like. The lifting apparatus may be described as a manhole cover lifting apparatus, pipe lifting apparatus, drain lifting apparatus, metal cover lifting apparatus, and/or cast-iron cover lifting apparatus. Description throughout to a manhole cover is for illustrative purposes and would apply to like objects. The maget of the magnetic engagement mechanism couples the apparatus to the manhole and a user utilizes the handle to lift up the manhole cover. The long vertical shaft 110 allows for a user to not have to bend over and potentially strain or hurt their back while lifting. Typically a worker would have to bend over and pry open a manhole cover. Lifting with improper posture can lead to wear and tear and even injuries to the worker. The lifting apparatus allows a user to lift the manhole cover without overextending any muscle groups.

The magnetic engagement mechanism is coupled to the shaft. This may be done in any number of ways. The magnetic engagement mechanism may be bolted to the shaft or otherwise affixed to the shaft by a fastener. In the illustrated embodiment, the magnetic engagement mechanism includes a magnetic mechanism cover 122 and a magnet 120. The magnet 120 forms the bottom of the lifting apparatus. The magnetic mechanism cover 122 is configured to cover and protect the maget 120 and protect the securing mechanism that couples the magnet to the shaft 110.

At the other end of the shaft 110, a handle is affixed or otherwise coupled to the top of the shaft. The handle includes a clamp 140 that is coupled to the shaft 110. The handle further includes at least one, and in the illustrated embodiment, two handle grips 130 that are removably coupled to the clamp 140. As can be seen, the axis of the handle grips 130 extend in a direction orthogonal to the axis of the shaft 110 forming a T-shape. As the handle grips 130 are removably coupled, they can be removed or flipped such that the axis of the handle grips 130 is parallel to the axis of the shaft 110. This is more fully shown in subsequent Figures.

FIG. 2 depicts an exploded perspective view of a lifting apparatus, according to one or more embodiments of this disclosure. Although the lifting apparatus 100 is shown and described with certain components and functionality, other embodiments of the lifting apparatus 100 may include fewer or more components to implement less or more functionality.

In FIG. 2, each of the components is more easily shown. The magnetic engagement mechanism is shown at the bottom of the Figure. The magnetic engagement mechanism includes a magnet 120, a magnetic mechanism cover 122, and a magnet securing bolt 124. In some embodiments, the magnet securing bolt 124 secures the magnet 120 to the magnetic mechanism cover 122. In some embodiments, the magnet securing bolt 124 secures the magnet 120 to the shaft 110 and the magnetic mechanism cover 122. In some embodiments, the magnet securing bolt 124 secures the magnet 120 to the shaft 110. The magnetic mechanism cover 122 covers and protects the magnet from damage.

Further depicted in FIG. 2, is the vertical shaft 110 and the handle. The handle includes the clamp 140 that is secured or coupled to the shaft 110. On each side of the clamp 140, there are female threaded connections. On the handle grips 130 are male threaded connections. The handle grips 130 can be threaded into the femle threaded connections of the clamp 140. Also depicted in FIG. 2 is a handle grip retention clasp 150. The handle grip retention clasp 150 is secured to the shaft 110 and can be used to store and hold the handle grips 130 when they are removed from the clamp 140 (which is shown more clearly in FIG. 8).

Referring to FIG. 3, a detail perspective view of a handle of a lifting apparatus according to one or more embodiments of this disclosure is shown. Although the handle is shown and described with certain components and functionality, other embodiments of the handle may include fewer or more components to implement less or more functionality.

The handle grips 130 are shown coupled into the clamp 140 and the clamp 140 is shown coupled or secured to the shaft 110. The handle grips 130 and the clamp 140 form an axis that is orthogonal to the axis of the shaft 110.

FIG. 4 depicts a detail perspective view of a magnetic engagement mechanism of a lifting apparatus, according to one or more embodiments of this disclosure. Although the magnetic engagement mechanism is shown and described with certain components and functionality, other embodiments of the magnetic engagement mechanism may include fewer or more components to implement less or more functionality. The magnetic engagement mechanism includes the magnetic mechanism cover 122 and the magnet 120 which are secured to the bottom of the shaft 110. In some embodiments, the magnet 120 forms the bottommost surface of the magnetic engagement mechanism so that the magnet 120 can engage the manhole cover.

In some embodiments, the shaft 110 and the clamp 140 may be constructed of a durable metal (for example, Aluminum). Other metals are contemplated herein. Additionally, the handle grips 130 may include a silicone grip (or other plastic, rubber, or metal material. Permutations of the materials is contemplated herein.

FIG. 5 depicts a perspective view of a lifting apparatus, according to one or more embodiments of this disclosure. Although the lifting apparatus 100 is shown and described with certain components and functionality, other embodiments of the lifting apparatus 100 may include fewer or more components to implement less or more functionality. The handle grip retention clasp 150 is shown secured to the shaft 110. The handle grip retention clasp 150 has two prongs on each side that the handle grips 130 can be snapped into.

FIG. 6 depicts a perspective view of a handle of a lifting apparatus resting in a partially disassembled state, according to one or more embodiments of this disclosure. Although the handle is shown and described with certain components and functionality, other embodiments of the handle may include fewer or more components to implement less or more functionality. FIG. 6 shows the handle grips 130 are removed from the clamp 140. One of the handle grips 130 has been snapped into the handle grip retention clasp 150. The other handle grip 130 is shown unscrewed from the female threaded connection on the clamp 140.

In some embodiments, the internal connections of the handle and the integration of the clamp 140, the shaft 110, and the handle grips 130 may be threaded. In some embodiments, the handle grips 130 are threaded into the clamp 140. In some embodiments, the shaft 110 is secured to the clamp 140 by two screws at the top of the clamp 140. In some embodiments, the handle grips 130 include a metal core with a molded rubber grip on the outside. Other variations are contemplated.

FIG. 7 depicts a cross-sectional side view of a magnetic engagement mechanism of a lifting apparatus, according to one or more embodiments of this disclosure. Although the magnetic engagement mechanism is shown and described with certain components and functionality, other embodiments of the magnetic engagement mechanism may include fewer or more components to implement less or more functionality. The cross-sectional view shows the integration of the magnet 120, the magnetic mechanism cover 122, and the magnet securing bolt 124. The magnet securing bolt 124 rests against the magnet and is screwed into the shaft 110. Other mechanisms of coupling the magnet to the shaft 110 are contemplated herein.

In some embodiments, the magnet 120 is surrounded by the magnetic mechanism cover 122 with the magnet 120 only exposed at the bottom. In some embodiments, there are four handle grips 130 with two secured in place in the clamp 140 and two snapped into the handle grip retention clasp.

FIG. 8 depicts a bottom view of a lifting apparatus, according to one or more embodiments of this disclosure. Although the lifting apparatus 100 is shown and described with certain components and functionality, other embodiments of the lifting apparatus 100 may include fewer or more components to implement less or more functionality. FIG. 8 shows more clearly the cover 122 circumferentially surrounding the magnet 120. FIG. 9 depicts a top view of a lifting apparatus, according to one or more embodiments of this disclosure. FIG. 10 depicts a front perspective view of a lifting apparatus, according to one or more embodiments of this disclosure.

FIG. 11 thru 30 depict another embodiment of a lifting apparatus 100 with various additional features. These features may be mixed with the features described in conjunction with FIG. 1 thru 10 even though they are not described together explicitly. A first feature includes a knuckle mechanism that allows the shaft to pivot relative to the magnet 120 and the magnetic mechanism cover 122. A second feature is an ability for the magnet to spin or rotate relative to the magnetic mechanism cover 122, the shaft 110, and ultimately the handle. A third feature is the ability of the handle grips 130 to rotate relative the clamp 140 while remaining coupled to the clamp 140. These features are described using the figures and are for illustrative purposes only.

Discussing the knuckle mechanism, the lifting apparatus 100 is configured to allow the shaft to rotate about a pin that runs through the base of the shaft and through the magnetic mechanism cover. The shaft 110 is configured to only rotate in one direction which is described in more detail below. In a neutral position, the shaft 110 is orthogonal to the bottom surface of the magnet 120. This is shown in FIGS. 17 and 18 among others. The magnetic mechanism cover 122 restricts motion in all directions except for one direction where a channel is formed. The shaft can rotate down into the channel and rotate relative to the magnet 120 and the magnetic mechanism cover 122. The axis about which the shaft rotates is parallel to the major axis of the handle grips. That is, the handle grips major axis is parallel to the pin (described in more detail below). This will be seen more easily in the description of the below figures.

Discussing the ability of the magnet to spin or rotate relative to the magnetic mechanism cover, the entire lifting apparatus 100 can be rotated after the magnet is coupled to, for example, a manhole cover. The magnet will magnetize to the cover and then the handle can be rotated to position the handles as the user desires. As described above, the shaft will only rotate into the channel 170 of the magnetic mechanism cover 122, so rotating the handles to a desirable position is beneficial to the user. As such, the magnet 120 is configured to spin or rotate relative to the magnetic mechanism cover 122, the shaft 110, and the handle grips 130.

Discussing the handle grips, they are configured to rotate down and out of the way for storage, which is shown in FIG. 37. Once rotated down, the handle grips 130 are parallel to the shaft 110.

Referring now to FIG. 11, a perspective view of a magnetic engagement mechanism of a lifting apparatus, according to one or more embodiments of this disclosure is depicted. As can be seen, the magnet 120 is positioned below the magnetic mechanism cover 122. The magnetic mechanism cover 122 includes a few features. Although the magnetic mechanism cover 122 is shown and described with certain components and functionality, other embodiments of the magnetic mechanism cover 122 may include fewer or more components to implement less or more functionality. The shaft 110 is surrounded by the magnetic mechanism cover 122 on all but one side of the shaft 110 where a channel 170 is located. This allows the shaft 110 to rotate down into the channel 170 as needed. The shaft 110 is restricted from rotating in any other direction than down into the channel 170. This allows the magnet 120 to stay magnetized on a cover (or other apparatus) and move the handles down into a better position to pull, for example, a manhole cover off a manhole. (This is shown more clearly in FIG. 28). Once the shaft 110 is returned to a neutral position (i.e., orthogonal to the bottom surface of the magnet 120), the shaft 110 can be pushed in any other direction which forces the magnetic mechanism cover 122 and the magnet 120 to rotate as well relative to a cover and can release the lifting apparatus 110 from the cover (see, for example, FIG. 29)

The magnetic mechanism cover 122 also includes a pin 180 that extends from one side to the other side of the magnetic mechanism cover 122 and runs through a hole on the shaft 110. The shaft 110 can rotate about this pin 180 (down into the channel 170 and back up to a neutral position). As described above, this knuckle allows a user to rotate the handles to the best angle for user to get leverage to lift, for example, a manhole cover off the manhole.

As can further be seen, the shaft 110 includes an oblong cross-sectional shape. The shaft 110 is elongated in the direction where the rotation takes place allowing the shaft to be strong enough to support those forces.

Referring now to FIG. 12, a perspective cut-away view of a magnetic engagement mechanism of a lifting apparatus, according to one or more embodiments of this disclosure is shown. The cutaway view shows the pin 180 as it goes through the shaft 110. Additionally, the bottom of the shaft 110 is shown, with a curved bottom to allow the shaft to rotate within the cavity and not interfere with the magnetic mechanism cover 122. The shaft 110 can rotate down into the channel 170. Additionally, there is a back cavity 175 within the magnetic mechanism cover 122 on an opposite side of the channel 170. This allows the bottom of the shaft 110 to rotate below the pin 180 and back into the back cavity 175 while the shaft 110 above the pin 180 rotates down into the channel 170.

Referring now to FIG. 13 a side cutaway view of a magnetic engagement mechanism of a lifting apparatus, according to one or more embodiments of this disclosure is shown. The pin 180 is shown and the back cavity 175 is more easily seen within the magnetic mechanism cover 122. Additionally, the rounded bottom edge 185 of the shaft is shown which allows the shaft to rotate and not interfere with the magnetic mechanism cover 122 or the magnet securing bolt 124 which secures the magnet 120 to the magnetic mechanism cover 122.

Referring now to FIG. 14 a front cutaway view of a magnetic engagement mechanism of a lifting apparatus, according to one or more embodiments of this disclosure is shown. The lengthwise axis of the pin 180 is now shown and how the pin 180 is secured to the magnetic mechanism cover 122.

Referring now to FIG. 15 a rear view of a magnetic engagement mechanism of a lifting apparatus, according to one or more embodiments of this disclosure is shown. The channel 170 cannot be seen and is on the opposite side. This view shows how the shaft is surrounded on all other sides by the magnetic mechanism cover 122 to restrict any rotation of the shaft 110 relative to the magnetic mechanism cover 122 in those directions. Additionally, the magnet 120 extends beyond the magnetic mechanism cover 122. This allows the lifting apparatus 100 to be rotated to release the magnet 120 from an object without the magnetic mechanism cover 122 getting in the way as the entire lifting apparatus is rotated relative to the magnetized object (such as a manhole cover).

Referring now to FIG. 16 a bottom view of a lifting apparatus, according to one or more embodiments of this disclosure is shown. The bottom view shows the bottom surface of the magnet 120. Addtionally, arrows 119 are added to show the direction of rotation of the magnet 120 relative the rest of the lifting apparatus 100. As previously described, after the magnet 120 is magnetized to an object, the handles and the rest of the lifting apparatus 100 can rotate to position the handles in the appropriate position. As the shaft only rotates in one direction, a user would need to rotate the handles to position orthogonal to the direction a user would like to pull. Doing this after the magnet 120 is magnetized to the object would be difficult without the ability of the magnet 120 to rotate relative the rest of the lifting apparatus.

Referring now to FIG. 17 a side view of a lifting apparatus, according to one or more embodiments of this disclosure is shown. The side view illustrates how the major lengthwise axis of the pin 180 is parallel to the major lengthwise axis of the handle grips 130. Additionally, the arrows 181 are shown to depict the rotational movement that the shaft 110 can make about the pin 180. The shaft 180 is shown in the neutral or most upright position. The shaft 110 can only rotate down in the one direction shown by the arrows 181 and back up to the neutral position.

Referring now to FIG. 18 a front view of a lifting apparatus, according to one or more embodiments of this disclosure is shown. The channel 170 is visible in FIG. 18. In the view of FIG. 25, the shaft would rotate forwards in front of the page.

Referring now to FIG. 19 a front view of a handle of a lifting apparatus, according to one or more embodiments of this disclosure is shown. The handle grips 130 are shown snapped up into user position. The handle grips 130 are orthogonal to the shaft 110. The handle grips 130 can rotate about handle pins 135. The handle grips 130 would rotate down towards the shaft 110 until the handle grips 130 are parallel with the shaft 110.

Referring now to FIG. 20 a front view of a magnetic engagement mechanism of a lifting apparatus, according to one or more embodiments of this disclosure is shown. In this view, the channel 170 is shown clearly. As described previously, the channel 170 allows the shaft 110 to rotate down without the magnetic mechanism cover 122 obstructing movement.

Referring now to FIG. 21 a bottom perspective view of a handle of a lifting apparatus, according to one or more embodiments of this disclosure is shown. This view better illustrates how the handle grips 130 can rotate down. The clamp 140 includes clamp channels 141 which allows the handle grips 130 to be rotated about the handle pins 135.

In some embodiments, the clamp channels 141 are shown with a slight overhang of the clamp 140 over the handle grips which forces the handle grips into either the up or down position.

Referring now to FIG. 22 a bottom perspective view of a handle of a lifting apparatus, according to one or more embodiments of this disclosure is shown. Referring now to FIG. 23 a perspective view of a handle of a lifting apparatus, according to one or more embodiments of this disclosure is shown. FIGS. 22 and 23 again shows the handle to better illustrate an example embodiment.

Referring now to FIG. 24 a rear perspective view of a magnetic engagement mechanism of a lifting apparatus, according to one or more embodiments of this disclosure is shown. This view better shows the magnetic mechanism cover 122 surrounding the shaft 110 except where the channel 170 is located.

Referring now to FIG. 25 a front perspective view of a magnetic engagement mechanism of a lifting apparatus, according to one or more embodiments of this disclosure is shown. This shows another angle of the channel 170.

Referring now to FIG. 26 a side view of a magnetic engagement mechanism of a lifting apparatus, according to one or more embodiments of this disclosure is shown. This shows the pin 180 more clearly.

Referring now to FIG. 27 a front view of a magnetic engagement mechanism of a lifting apparatus, according to one or more embodiments of this disclosure is shown. This view depicts the channel 170 from straight on.

Referring now to FIG. 28 a lifting apparatus is shown in use, according to one or more embodiments of this disclosure. As can be seen, the magnet 120 is magnetized to object 200 (in this case a manhole cover). The handle and the shaft 110 has rotated relative to the magnetic mechanism cover 122 and the magnet 120 to allow the user to pull the manhole cover off the manhole. The user can pull in a direction substantially parallel with the axis of the shaft 110 because the shaft 110 rotates relative to the magnetic mechanism.

Referring now to FIG. 29 a lifting apparatus is shown in use, according to one or more embodiments of this disclosure. The user has now pulled the object 200 (manhole cover) off the manhole and wants to disengage the magnet 120 from the object 200. The user has pushed the handle of the lifting apparatus 100 back in the opposite direction from the channel 170. This forces the magnet 120 to now rotate and disengage from the object 200.

Referring now to FIG. 30 a lifting apparatus is shown in use, according to one or more embodiments of this disclosure. The user has now repositioned the lifting apparatus on an opposite end of the object 200. Again, the channel 170 (not visible) is oriented in the direction in which the user wants to pull the object 200. The shaft 110 has rotated relative the magnetic mechanism as can be seen. FIGS. 39 through 41 show a use case for the lifting apparatus making it easy to remove and/or replace a manhole cover. Other uses of the lifting apparatus are contemplated and this example is for illustrative purposes only.

In some embodiments, a lifting apparatus includes a vertical shaft, and a magnetic engagement mechanism coupled to a first end of the vertical shaft, the first end being a bottom of the vertical shaft, wherein the magnetic engagement mechanism comprises a magnet that is configured to engage a metal object. In some embodiments, the lifting apparatus further includes a handle coupled to a second end of the vertical shaft, the second end being located at an opposite end of the vertical shaft from the first end, the second end being a top of the vertical shaft.

In some embodiments, the lifting apparatus further comprises a pin that couples the magnetic engagement mechanism to the vertical shaft and is configured to allow the vertical shaft to rotate relative to the magnetic engagement mechanism about the pin.

In some embodiments, the magnetic engagement mechanism further comprises a magnetic mechanism cover that covers the magnet and exposes the magnet on a bottom of the lifting apparatus.

In some embodiments, the magnetic mechanism cover comprises a channel which restricts motion of the vertical shaft in all directions except for one direction where the channel is formed.

In some embodiments, the magnet is coupled to the magnetic mechanism cover and the magnet is configured to spin or rotate relative to the magnetic mechanism cover.

In some embodiments, the magnet is configured to spin or rotate relative to the vertical shaft.

In some embodiments, the magnet is configured to spin or rotate relative to the handle.

In some embodiments, the handle comprises handle grips and a clamp that couples the handle grips to the vertical shaft.

In some embodiments, the handle grips are configured to rotate relative to the clamp.

In some embodiments, the clamp further comprises clamp channels, wherein the clamp channels direct the handle grips between an up position and a down position relative to the vertical shaft.

In some embodiments, in the up position, the handle grips are perpendicular to the vertical shaft.

In some embodiments, in the down position, the handle grips are parallel to the vertical shaft.

In some embodiments, the clamp channels further comprise an overhang which forces the handle grips into either the up position or the down position.

In some embodiments, the magnetic engagement mechanism is configured to rotate relative to the vertical shaft.

In some embodiments, a lifting apparatus includes a vertical shaft, and a magnetic engagement mechanism coupled to a first end of the vertical shaft, the first end being a bottom of the vertical shaft, wherein the magnetic engagement mechanism comprises a magnet that is configured to engage a metal object, wherein the magnetic engagement mechanism is configured to rotate relative to the vertical shaft. In some embodiments, the lifting apparatus further includes a handle coupled to a second end of the vertical shaft, the second end being located at an opposite end of the vertical shaft from the first end, the second end being a top of the vertical shaft.

In some embodiments, the lifting apparatus further includes a pin that couples the magnetic engagement mechanism to the vertical shaft and is configured to allow the vertical shaft to rotate relative to the magnetic engagement mechanism about the pin.

In some embodiments, the magnetic engagement mechanism comprises a channel which restricts motion of the vertical shaft in all directions except for one direction where the channel is formed.

In some embodiments, the magnet is configured to spin or rotate relative to the vertical shaft and handle.

In some embodiments, the handle comprises handle grips and a clamp that couples the handle grips to the vertical shaft, and wherein the handle grips are configured to rotate relative to the clamp.

In some embodiments, the lifting apparatus further comprises a pin that couples the magnetic engagement mechanism to the vertical shaft and is configured to allow the vertical shaft to rotate relative to the magnetic engagement mechanism about the pin. In some embodiments, the magnetic engagement mechanism comprises a channel which restricts motion of the vertical shaft in all directions except for one direction where the channel is formed. In some embodiments, the magnet is configured to spin or rotate relative to the vertical shaft and handle

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Reference throughout this specification to features, advantages, or similar language does not imply that all of the features and advantages that may be realized with the subject matter of the present disclosure should be or are in any single embodiment. Rather, language referring to the features and advantages is understood to mean that a specific feature, advantage, or characteristic described in connection with an embodiment is included in at least one embodiment of the present disclosure. Thus, discussion of the features and advantages, and similar language, throughout this specification may, but do not necessarily, refer to the same embodiment.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Although specific embodiments of the invention have been described and illustrated, the invention is not to be limited to the specific forms or arrangements of parts so described and illustrated. The scope of the invention is to be defined by the claims appended hereto and their equivalents.

As used herein, the phrase “at least one of”, when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A lifting apparatus, the lifting apparatus comprising:
a vertical shaft;
a magnetic engagement mechanism coupled to a first end of the vertical shaft, the first end being a bottom of the vertical shaft, wherein the magnetic engagement mechanism comprises a magnet that is configured to engage a metal object; and
a handle coupled to a second end of the vertical shaft, the second end being located at an opposite end of the vertical shaft from the first end, the second end being a top of the vertical shaft.

2. The lifting apparatus of claim 1, further comprising a pin that couples the magnetic engagement mechanism to the vertical shaft and is configured to allow the vertical shaft to rotate relative to the magnetic engagement mechanism about the pin.

3. The lifting apparatus of claim 2, wherein the magnetic engagement mechanism further comprises a magnetic mechanism cover that covers the magnet and exposes the magnet on a bottom of the lifting apparatus.

4. The lifting apparatus of claim 3, wherein the magnetic mechanism cover comprises a channel which restricts motion of the vertical shaft in all directions except for one direction where the channel is formed.

5. The lifting apparatus of claim 4, wherein the magnet is coupled to the magnetic mechanism cover and the magnet is configured to spin or rotate relative to the magnetic mechanism cover.

6. The lifting apparatus of claim 5, wherein the magnet is configured to spin or rotate relative to the vertical shaft.

7. The lifting apparatus of claim 6, wherein the magnet is configured to spin or rotate relative to the handle.

8. The lifting apparatus of claim 1, wherein the handle comprises handle grips and a clamp that couples the handle grips to the vertical shaft.

9. The lifting apparatus of claim 8, wherein the handle grips are configured to rotate relative to the clamp.

10. The lifting apparatus of claim 9, wherein the clamp further comprises clamp channels, wherein the clamp channels direct the handle grips between an up position and a down position relative to the vertical shaft.

11. The lifting apparatus of claim 10, wherein in the up position, the handle grips are perpendicular to the vertical shaft.

12. The lifting apparatus of claim 11, wherein in the down position, the handle grips are parallel to the vertical shaft.

13. The lifting apparatus of claim 12, wherein the clamp channels further comprise an overhang which forces the handle grips into either the up position or the down position.

14. The lifting apparatus of claim 1, wherein the magnetic engagement mechanism is configured to rotate relative to the vertical shaft.

15. A lifting apparatus, the lifting apparatus comprising:
a vertical shaft;
a magnetic engagement mechanism coupled to a first end of the vertical shaft, the first end being a bottom of the vertical shaft, wherein the magnetic engagement mechanism comprises a magnet that is configured to engage a metal object, wherein the magnetic engagement mechanism is configured to rotate relative to the vertical shaft; and
a handle coupled to a second end of the vertical shaft, the second end being located at an opposite end of the vertical shaft from the first end, the second end being a top of the vertical shaft.

16. The lifting apparatus of claim 15, further comprising a pin that couples the magnetic engagement mechanism to the vertical shaft and is configured to allow the vertical shaft to rotate relative to the magnetic engagement mechanism about the pin.

17. The lifting apparatus of claim 15, wherein the magnetic engagement mechanism comprises a channel which restricts motion of the vertical shaft in all directions except for one direction where the channel is formed.

18. The lifting apparatus of claim 15, wherein the magnet is configured to spin or rotate relative to the vertical shaft and handle.

19. The lifting apparatus of claim 15, wherein handle comprises handle grips and a clamp that couples the handle grips to the vertical shaft, and wherein the handle grips are configured to rotate relative to the clamp.

20. The lifting apparatus of claim 15, wherein the lifting apparatus further comprises a pin that couples the magnetic engagement mechanism to the vertical shaft and is configured to allow the vertical shaft to rotate relative to the magnetic engagement mechanism about the pin,
wherein the magnetic engagement mechanism comprises a channel which restricts motion of the vertical shaft in all directions except for one direction where the channel is formed, and
wherein the magnet is configured to spin or rotate relative to the vertical shaft and handle.
